(19) United States
(12) Patent Application Publication
(10) Pub. No.: US 2004/0184756 A1
(43) Pub. Date: Sep. 23, 2004

(54) Method of manufacturing optical waveguide and the optical waveguide

(75) Inventors: Naoki Hanashima, Tokyo (JP); Tohru Oikawa, Tokyo (JP); Reio Mochida, Tokyo (JP); Tohru Kineri, Tokyo (JP)

Correspondence Address: MCGINN & GIBB, PLLC, 8321 OLD COURTHOUSE ROAD, SUITE 200, VIENNA, VA, 22182-3817, US

(73) Assignee: TDK Corporation, Tokyo (JP)

(21) Appl. No.: 10/804,153

(22) Filed: Mar. 19, 2004

(30) Foreign Application Priority Data
Mar. 20, 2003 (JP) 2003-077346

(51) Int. Cl. G02B 6/10

(52) U.S. Cl. 385/129

(57) ABSTRACT

An optical waveguide is formed on a substrate 11 by the steps of (1) forming an lower clad layer 12, core layer 13, metal mask layer 14 and a photoresist layer 15, (2) patterning the photoresist layer 15 by using a photomask 16, (3) etching and patterning the metal mask layer 14 wider than a core of required width using the patterned photoresist layer 15, (4) removing the photoresist layer and the metal mask layer 14 after patterning the core layer 13 by using the patterned metal mask layer 14 to form core 13a, (5) forming an upper clad layer 17 on the lower clad layer 12 so as to bury the patterned core 13a.

### BACKGROUND OF THE INVENTION

The present invention relates to a method of fabricating an optical waveguide, and more specifically, to a technique that can be effectively applied to the formation of a core comprising the optical waveguide.

While evolution of optical communication systems has been demanding the integration and the sophistication of optical components, optical waveguide devices fabricated by planer process are expected to meet the above demand with low cost. Optical waveguides made of silica-based materials are in wide use since they are highly reliable and low insertion loss, and they are compatible with optical fibers that are also made of silica glass.

An optical waveguide is comprised of a core that is formed on a substrate and has a relatively high refractive index, and a clad that is an area of low refractive index surrounding the core. Light is confined in the core due to the refractive index difference between the core and the clad. The refractive index difference and the size of those are designed so that the light propagating though a core can be coupled to an optical fiber with low loss.

A typical silica-based optical waveguide is fabricated, firstly by depositing a lower clad layer and a core layer on a silica or silicon substrate by the Flame Hydrolysis Deposition (FHD), Chemical Vapor Deposition (CVD), sputtering, etc, followed by depositing a metal mask layer on the core. A photoresist layer is then spin-coated on the metal mask layer.

The next, the core layer is patterned to a waveguide layout using a technique of photolithography. Firstly the photoresist layer is patterned by exposing through a photomask and then developing the photoresist. A metal mask is etched by using the photoresist pattern as an etching mask. The core layer is etched with the metal mask so as to form a waveguide core that is almost rectangular in its cross section. A method such as reactive ion etching (RIE) may be used for the etching process. The optical waveguide is completed after the deposition of an upper clad layer and subsequent annealing so that moisture contained in the films or internal stress induced during the processes can be removed.

Light propagating in an optical waveguide is considerably affected by the distribution of refractive indices around a core. For instance, an etching condition is determined considering the residue deposited after the etching process since it can increase propagation loss.

Japan Unexamined Patent Publication No. 1995-77619 discloses a method of fabricating an optical waveguide, in which a channel waveguide is annealed before covering a core of the waveguide with an upper clad layer by the FHD so as to eliminate fine irregularities or any deteriorated layer that were generated dung the photolithography and etching process and thereby to reduce propagation loss.

Meanwhile, Japan Unexamined Patent Publication No. 2000-75157 discloses a method of fabricating an optical waveguide, in which a core width in a grating area is matched with that in the rest of the area. Japan Unexamined Patent Publication No. 1998-10347 discloses a technique of controlling a core width by changing etching conditions.

The mechanism of etching can be roughly categorized into two types: one is so-called “physical etching” wherein such inactive ion as Argon impinges an object to be etched and blows it of, and the other is “chemical etching” that vaporizes an object to be etched by using chemical reactions of reactive gas. In the physical etching, etching proceeds more toward the surface normal direction of a substrate while it proceeds less toward the direction of the substrate surface since directions of ion flux are relatively uniformed. This means that the physical etching is highly anisotropic and is, however, disadvantageous in terms of that the blown-off residues might deposit on the periphery of the object to be etched.

There is another problem of resistance of a masking layer in etching because energy of the ion flux is high. For instance, when a patterned masking layer has poor perpendicularity at the edge and is formed trapezoidal, the width of the masking layer decreases after the etching and therefore a pattern with underneath it will decrease as well.

On the other hand, although no residues deposit in the chemical etching, etching proceeds more toward lateral direction since it is more isotropic after etched deep. Here the depth direction refers to a direction of lamination of the clad and the core layers, and a lateral direction refers to a direction orthogonal to the lamination.

In fabricating of optical waveguides, it is preferable that a core is etched in a condition that chemical etching is dominant. There is a problem, however, that core widths become narrower than their design since the etched amount in the lateral direction is indispensable, and thus a waveguide could not be fabricated exactly as it had been designed. This could increase coupling loss and hence requirements for optical characteristics would not be satisfied.

A technique to remove roughness and corrugation on the side surfaces of a core and to reduce propagation loss, as described in Japan Unexamined Patent Publication No. 1995-77619, does not consider possible increase in coupling loss due to the core width decrease. A technique to equalize widths of cores wherever the cores are formed, as described in Japan Unexamined Patent Publication No. 2000-75157, also gives no consideration for matching the core widths exactly to designed values. In addition, if we could control the core widths more conveniently than the technique of controlling the core widths by changing etching conditions as described in Japan Unexamined Patent Publication No. 1998-10347, it would be more preferable for easily production.

Now, the inventor has realized that the etched amount in the lateral direction and the depth direction in etching a core varies depending on an area to be etched. In other words, in waveguides with their cores sandwiching a gap, the etched amounts between the gap side of a core and the opposite side differ, which causes a problem that a waveguide is not fabricated into a designed shape, and thus designated optical characteristics cannot be obtained.

### SUMMARY OF THE INVENTION

It is therefore an object of the present invention to provide a method of fabricating an optical waveguide with its core width that matches to the design in advance, while avoiding residues by etching.

According to an aspect of the present invention, there is provided a method of fabricating an optical waveguide comprising the steps of: forming a core layer on a substrate or a first clad layer; forming a masking layer on the core layer; forming the photoresist layer on the masking layer; patterning the photoresist layer using a photomask; patterning the masking layer wider than a required core width by using the patterned photoresist layer; removing the masking layer after forming the core by patterning the core layer by using the patterned masking layer; and forming a second clad layer on the first clad layer by burying the patterned core.

According to the invention, since core width decreased after etching is corrected by forming a masking layer that is wider than a required core width, a core of an optical waveguide with the width that matches to the design in advance can be obtained without etching residues deposition.

In a preferred embodiment of the invention, the width of the core patterned by using the masking layer is equal to the designed core width.

This would enable to obtain a core of an optical waveguide having its width that matches to designed dimensions, without etching residues deposition.

In a further preferred embodiment of the invention, when the cores sandwiches a gap, the masking layer is patterned so that a center position of the width of the patterned masking layer will be farther away from the gap than a center position of the width of the core.

This would enable to obtain core widths that match to required dimensions while avoiding etching residues, even when two adjacent cores sandwiches a gap.

In a still further preferred embodiment of the invention, the masking layer will be patterned wider than the required width by means of widening at least either one of the following: a mask pattern of a photomask used in patterning the photoresist layer, the patterning condition of the photoresist layer, or the patterning condition of the masking layer.

This would enable to a core of an optical waveguide having its width that matches to required dimensions, while avoiding residues by etching.

In a further preferred embodiment of the invention, the masking layer and the core layer is patterned by the Reactive Ion Etching.

This would enable to a core of an optical waveguide having its width made to required dimensions without etching residues deposition

In a still further preferred embodiment of the invention, the required core width would be 8 μm when a difference of refractive index is 0.3%, 7 μm when the difference of refractive index is 0.4%, 6 μm when the difference of specific refractive index is 0.7% and 5 μm when the difference of refractive index is 1.0%.

This would enable to form a core of ax% optical waveguide having its width made to required dimensions without etching residues deposition.

In a further preferred embodiment of the invention, a width of the masking layer would be 1.2 to 1.4 μm wider than the required core width when it is 7 to 8 μm.

This would enable to form a core of an optical waveguide having its width that matches to required dimensions without etching residues deposition.

According to another aspect of the present invention, there is also provided an optical waveguide at least comprised of a core and a clad, characterized by that the core is patterned by using a photomask, and that a pattern width of a part corresponding to the core in the photo mask is wider than the core width.

According to this invention, as the core width reduced by etching could be corrected by the photomask, it would become possible to form a core of an optical waveguide having its width that matches to required dimensions while without etching residues deposition.

In a preferred embodiment of the invention, the pattern width would not be less than 0.5 μm wider than the core width.

This would enable to form a core of an optical waveguide having its width that matches required dimensions while avoiding residues by etching.

According to yet another aspect of the present invention, there is also provided an optical waveguide at least comprised of a core and clad, wherein the core width d is:

d<1.45λ/(2(√(n_{core}²−n_{clad}²)))

where a refractive index of the core is n_{core}, that of the clad is n_{clad}, and cutoff wavelength of the optical waveguide is λ, and width M of a corresponding part of the masking layer that patterns the core will be:

M>1.45λ)/(2(√(n_{core}²−n_{clad}²))).

This invention would allow us to form a core of an optical waveguide having its width that matches required dimensions while avoiding residues by etching.

In a preferred embodiment of the invention, the cutoff wavelength is 80 to 90% of wavelength in use.

This would enable to form a core of an optical waveguide having its width that matches to required dimensions without etching residues deposition.

### BRIEF DESCRIPTION OF THE DRAWINGS

FIG. 1 is a cross sectional view of showing a process of a method of fabricating an optical waveguide which is one embodiment of the invention;

FIG. 2 is a cross sectional view of a process following FIG. 1 of the method of fabricating an optical waveguide which is one embodiment of the invention;

FIG. 3 is a cross sectional view of a process following FIG. 2 of the method of fabricating an optical waveguide which is one embodiment of the invention;

FIG. 4 is a cross sectional view of a process following FIG. 3 of the method of fabricating an optical waveguide which is one embodiment of the invention;

FIG. 5 is a cross sectional view of a process following FIG. 4 of the method of fabricating an optical waveguide which is one embodiment of the invention;

FIG. 6 is a cross sectional view of a process following FIG. 5 of the method of fabricating an optical waveguide which is one embodiment of the invention;

FIG. 7 is a cross sectional view of a process following FIG. 6 of the method of fabricating an optical waveguide which is one embodiment of the invention;

FIG. 8 is a cross sectional view of a process following FIG. 7 of the method of fabricating an optical waveguide which is one embodiment of the invention;

FIG. 9 is a cross sectional view showing a masking layer considered by the inventor an object to be reviewed and a core etched hereby;

FIG. 10 is a cross sectional view showing the making layer in the method of fabricating an optical waveguide, which is one embodiment of the invention, and the core etched hereby;

FIG. 11 is a graph showing a relationship between a gap defined by two cores and width of the cores;

FIG. 12 is a schematic diagram showing a relationship between a branching pattern and the masking layer;

FIG. 13 is a cross sectional view showing a masking layer in a method of fabricating an optical waveguide, which is another embodiment of the invention and a core, etched hereby;

FIG. 14 is a graph showing a relationship of the refractive index difference and core width/height for two cutoff wavelengths; and

FIG. 15 is a graph showing dispersion characteristics of a three-dimensional channel optical waveguide.

### DETAILED DESCRIPTION OF THE PREFERRED EMBODIMENTS

In the following, we specifically describe embodiments of the invention with reference to the accompanying drawing, wherein same symbols are given to same members and overlapped description is omitted. In addition, embodiments of the invention shall be useful, in particular, when this invention is carried out and it is not intended to limit this invention to the embodiments of the invention.

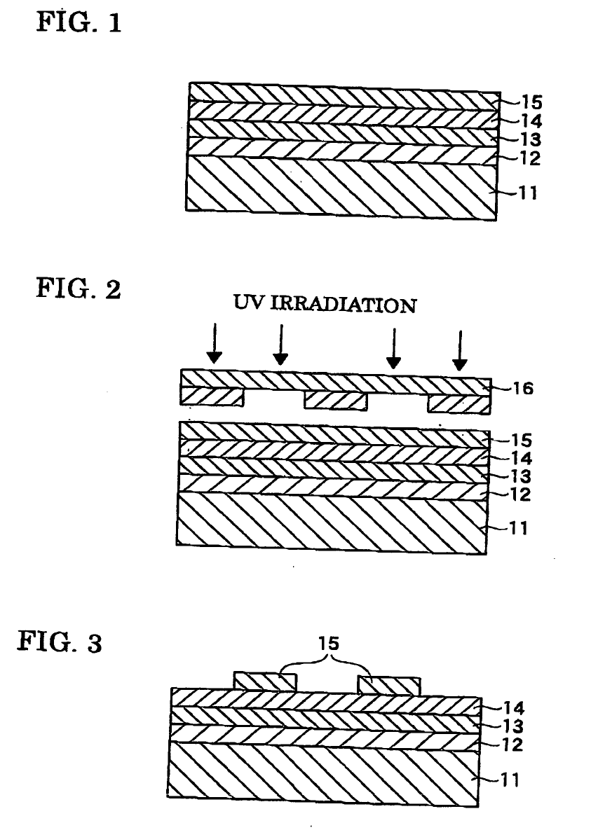

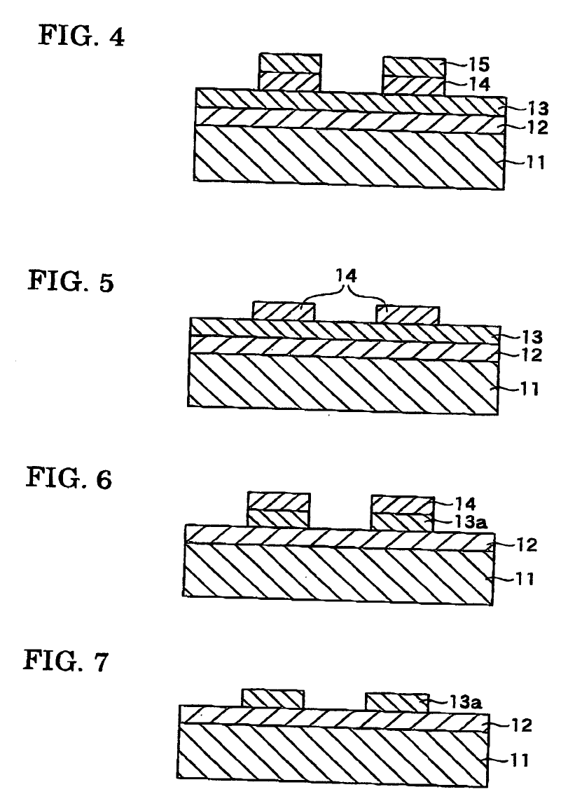

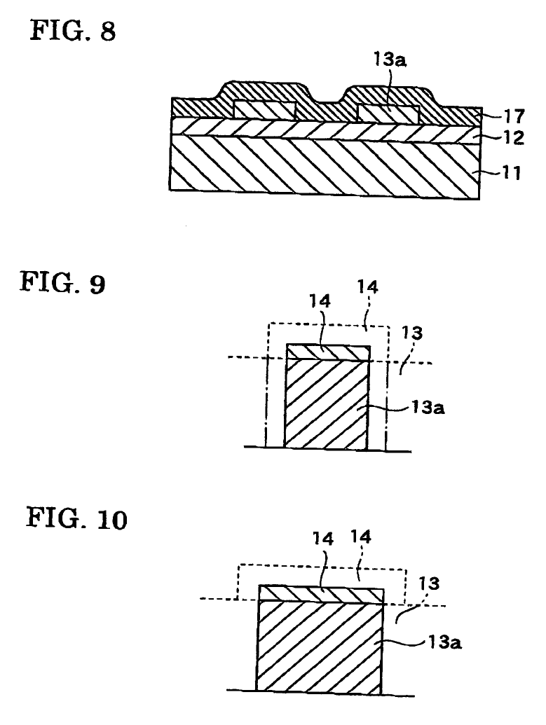

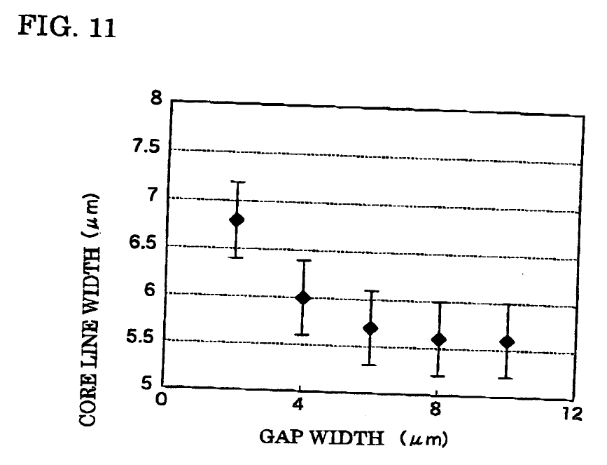

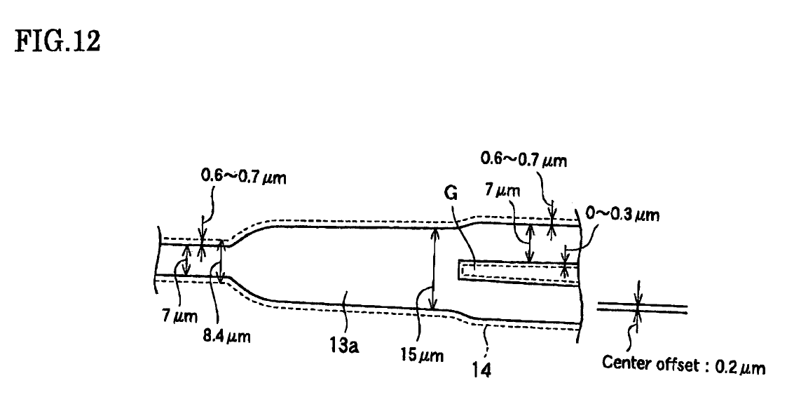

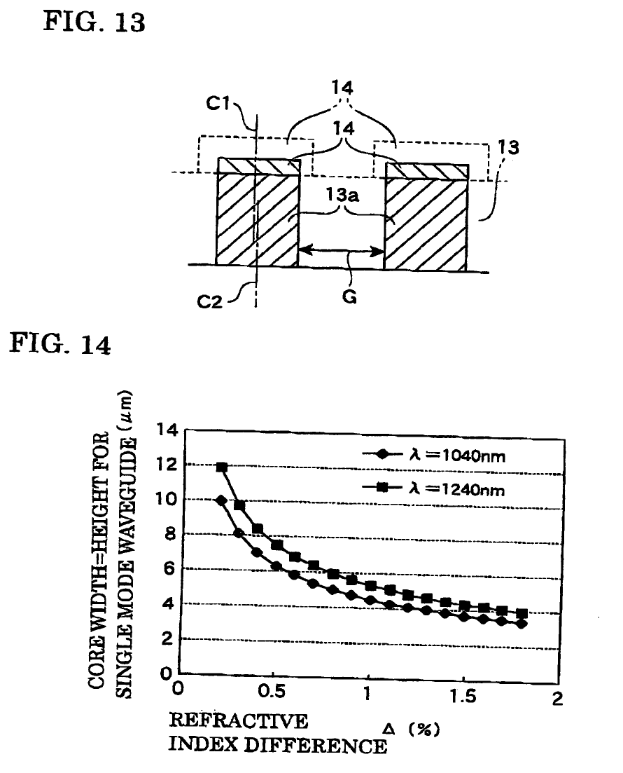

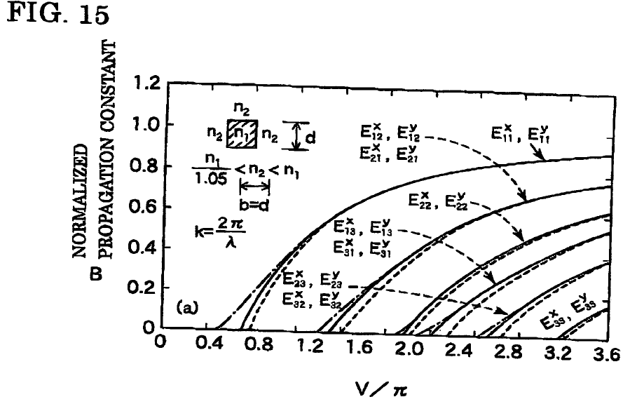

FIG. 1 is a cross sectional view showing a process of a method of fabricating an optical waveguide which is one embodiment of the invention; FIG. 2 is a cross sectional view of a process following FIG. 1 of the method of fabricating an optical waveguide which is one embodiment of the invention; FIG. 3 is a cross sectional view of a process following FIG. 2 of the method of fabricating an optical waveguide which is one embodiment of the invention; FIG. 4 is a cross sectional view of a process following FIG. 3 of the method of fabricating an optical waveguide which is one embodiment of the invention; FIG. 5 is a cross sectional view of a process following FIG. 4 of the method of fabricating an optical waveguide which is one embodiment of the invention; FIG. 6 is a cross sectional view of a process following FIG. 5 of the method of fabricating an optical waveguide which is one embodiment of invention; FIG. 7 is a cross sectional view of a process following FIG. 6 of the method of fabricating an optical wave guide which is one embodiment of invention; FIG. 8 is a cross section view of a process following FIG. 7 of the method of fabricating an optical waveguide which is one embodiment of invention; FIG. 9 is a cross sectional view showing a masking layer considered by the inventor an object to be reviewed and a core etched hereby; FIG. 10 is a cross sectional view showing the masking layer in the method of fabricating an optical waveguide which is one embodiment of the invention and the core etched hereby; FIG. 11 is a graph showing a relationship between a gap defined by two cores and core width after etching; FIG. 12 is a schematic diagram showing a relationship between a branching core and the masking layer; FIG. 13 is a cross sectional view showing a masking layer in a method of fabricating an optical waveguide which is another embodiment of the invention and a core etched hereby; FIG. 14 is a graph showing a relationship of the refractive index difference and core width/height for two cutoff wavelengths; and FIG. 15 is a graph showing dispersion characteristics of a three-dimensional channel optical waveguide.

First, we describe a series of processes of a method of fabricating an optical waveguide in the present embodiment by taking a silica-based optical waveguide as an example. However, in addition to silica, other materials such as silicon may also be used as a substrate.

Firstly, a lower (first) clad layer 12 of 5 μm (15 μm for silicon substrate) thickness made of non-doped silica glass is formed on a silica substrate by CVD. A mixture of TEOS (tetraethyoxy-orthosilicate) and oxygen is used as a source gas. A core layer 13 of 7 μm thickness is then formed with a mixture of TMG (tetramethoxy-germanium), TEOS, and oxygen as a source gas before the substrate will be annealed at 1100° C. for three hours. In addition, after forming WSi (tungsten silicide) layer of 700 nm thickness by sputtering, as a metal mask layer (masking layer) 14 for patterning, photoresist layer 15 is formed on the WSi. This would form a laminated body as shown in FIG. 1.

Next, a technique of photolithography, as shown in FIG. 2, the photoresist layer 15 will be patterned shown in FIG. 3. Although the positive-photoresist is used in the shown embodiment, negative-photoresist can be used as well.

Moreover, the metal mask layer 14 is patterned by the patterned photoresist layer 15 with CF₄ and SF₆ as an etching gas in RIE process, as shown in FIGS. 4, 5. Physical and chemical etching reactions always coexist in RIE, and thus it is possible to optimize fabrication condition by balancing those etchings. The metal mask layer 14 patterning follows removing of the photoresist layer 15 by oxygen plasma ashing.

A core 13a is then formed by etching the core layer 13 with the patterned metal mask layer 14, using a mixed gas of CHF₃ and CH₄ in RIE (FIG. 6). The metal mask layer 14 is removed by using SF₆ gas (FIG. 7) after the core formation.

Finally, the optical waveguide is completed after forming an upper clad layer (a second clad layer) 17 on the lower clad layer 12 to bury the patterned core 13a, as shown in FIG. 8. BPSG (silicate glass doped with boron and phosphor) that can be softened at low temperatures is used as the upper clad layer 17 rather than no-doped silica, since it shows better coverage for cores that are positioned closely each other when used as an upper clad. Then the BPSG up to thickness of 30 μm by CVD using a mixed gas of TMB (trimethoxy-boron) and TMP (tetramethoxy-phosphate) together with TEOS and oxygen gas is deposited before the substrate will be annealed at 1100° C. for 24 hours for the purpose pf softening to flow or mitigation of stress, etc.

As described above, in the embodiments of the invention, optical waveguides are fabricated by chemical etching that uses reactive gas. In FIGS. 9, 10, and 13, the core layer 13 and the metal mask layer 14 before etching are shown by the broken line, while the core layer 13 and the metal mask layer 14 after etching are shown by the solid line with hatching. As stated above, although chemical etching has the advantage of generating less etching residue, as shown in FIG. 9, the etching in lateral direction proceeds as much as in depth direction, and the width of the patterned core 13a will be narrower than the designed core width shown by the dashed line in FIG. 9. Here this excess etching is referred to as overetching. To be specific, the over etching is approximately 1.2 to 1.4 μm in lateral direction when depth of the etching is 7 to 8 μm, and is approximately 7.0 to 8.8 μm when 28 μm. Moreover the over etching is 9.8 to 11.0 μm in the lateral direction when depth of the etching is 40 μm.

The metal mask layer 14 is patterned following the patterned photoresist layer 15 so that the width of the metal mask is wider than a design core width (i.e. required width) instead of being equal to, as shown in FIG. 10. Specifically, the over etching is 1.2 to 1.4 μm in lateral direction when cross sectional dimensions of a required core are 7 to 8 μm in rectangular (i.e. core width is 7 to 8 μm). Accordingly the metal mask layer 14 will be patterned to its width of 8.2 to 8.4 μm (for a core width of 7 μm) or 9.2 to 9.4 μm (for a core width of 8 μm. Similarly, when a required core width is 28 μm in rectangular, it will be patterned to 35.0 to 36.8 μm and 49.8 to 51.0 μm in width when the required core width is 40 μm. This means that the width of the metal mask layer 14 that is wider by greater than 1.0 μm than required core width is preferable. The width wider by greater than 0.5 μm is more preferable considering actual fabricating accuracy (i.e. dimensional error).

As in the following descriptions, the metal masking layer 14 can be patterned to the above widths by widening patterns width of the photomask 16. It can also be done by widening those of the photoresist layer 15 or of the metal mask layer, or the combination of two of the above three methodology.

Consequently, the metal mask layer 14 that is patterned wider than its designed width enables to present a core having its width that matches with the designed width (for instance, the metal mask layer 14 of 8.2 to 8.4 μm width is used for the designed core of 7 μm width).

In the following, we describe a “required core width” used herein. Difference of refractive indices of the core 13a and the clads 12, 17 (or refractive index difference: Δ=(n_{core}−n_{clad})/n_{clad}) and size of the core 13a (cross sectional height and width) determines propagation characteristics of an optical waveguide.

Optical waveguides that are used in connection with a single mode fiber are designed to be single mode in consideration of possible coupling loss to the fiber. Although the size of the core 13a is reduced to be a single mode for large refractive index difference, a small core would lead to poor. On the other hand, propagation loss at a bend would increase when refractive index difference are small. Thus decreasing the minimum bending radius of a pattern to miniaturize the size of a waveguide device would result in bending loss increase.

Taking the above tradeoff into account, combinations of core size and refractive index difference listed in table 1 may often be used.

TABLE 1

| Height/Width of | Refractive Index | Coupling Loss | Acceptable Bend |
|---|---|---|---|
| Core (μm) | Difference (%) | with Fiber (dB) | Radius (mm) |
| 8 | 0.3 | 0 | 25 |
| 7 | 0.4 | 0.1 | 17 |
| 6 | 0.7 | 0.3 | 7 |
| 5 | 1.0 | 1.2 | 3 |

Although there may be advantageous and disadvantageous in each case in terms of coupling loss or acceptable bend radius, they all are usually acceptable. We can determine a core width and height from refractive index difference according to the table. This means that core width is designed 8 μm, and 5 μm for refractive index difference of 0.3% and 1.0%. A “required core width” used herein refers to a core width determined by refractive index difference and based on the relationship in Table 1.

According to the embodiments of the invention, an optical waveguide having required width can be presented since the core width reduced from etching is corrected by forming the metal mask layer 14 wider than required core width without residues deposition. Therefore, both propagation loss and coupling loss of a wave guide can be reduced.

FIG. 11 shows a relationship between a gap sandwiched by a pair of cores and the core (line) width.

It is realized from FIG. 11 that reduction of core width varies from 0.1 to 1.8 μm, and the narrower a gap width is, the smaller the core width reduction is.

In waveguide layouts, the pattern in which cores sandwich a gap is only used at a branch or coupling region. An isolated core corresponds to the pattern with a gap of 8 μm or wider, shown in the figure. The width reduction will exceed 1 μm in this case. Moreover, the gap width is required at the minimum approximately 2 μm considering reproductivity and the need of gap-fill process with the upper clad 17 after the core is patterned. The width reduction is 0 to 0.6 μm in this case.

As shown in FIG. 12 or 13, the metal mask layer 14 is patterned so that the center position C1 along the width direction of the metal mask layer 14 at a branch section of the core 13a will be farther away from the gap G in between the two cores 13a at the branch than the center C2 of the core 13a (in the case of FIG. 12, a distance between C1 and C2 is 0.2 μm).

This would enable to form a core width to required dimensions even when a paw of two cores 13a sandwiches gap C as shown in FIG. 13 without residues deposition.

Values in FIG. 12 are simply an example, and the invention will not be limited to them.

Single mode condition of a three-dimensional channel waveguide can be derived from a well-known relationship between normalizing frequency and normalized propagation constant. It provides 2d/λ−(√(n_{core}²−n_{clad}²))<1.45 for a square shaped core. λ is the cutoff frequency of the 1^{st} higher mode. It is realized that core width d (width d=height for square shaped core) can be determined from refractive indices and cutoff wavelength of core n_{core} and clad n_{clad}. FIG. 14 shows a relationship of refractive index difference and core width/height for two different cutoff wavelengths.

FIG. 15 shows dispersion characteristics of a three-dimensional channel optical waveguide. n₁ and n₂ in the figure denote refractive indices of core and clad, respectively, and Eᵢⱼ represents each propagation mode in a wavelength.

The horizontal axis represents a normalizing frequency V, which is given by the follow expression,

v=2πd√(n_{core}²−n_{clad}²)/λ

The vertical axis represents a normalized propagation constant B, which is given by the following expression,

B=(β²−n_{clad}²k²)/(n_{core}²k²−n_{clad}²k²),

where the propagation constant of a mode is β.

The lines in the figure represent calculated propagation constants of modes in which the light at a certain wavelength propagates in a waveguide, wherein solid and dashed lines represent approximated values in the calculations. Superscript x and y represent different polarizations. When a symmetrical clad surrounds a core that is approximately square shaped, curves for Ex and Ey almost coincide.

The frequency at which propagation constant is 0 is referred to as cutoff frequency. Light cannot propagate in propagation mode below the frequency. Moreover, V/π is required to be 1.4˜1.6 (typ: 1.45) since a single mode waveguide supports only a fundamental mode and let higher mode has to be cut off at the frequency in use. Therefore the single mode condition of a three-dimensional channel waveguide is 2d/λ−(√(n_{core}²−n_{clad}²))<1.45.

It is realized from the above equation that the required core width d is required satisfy d<1.45 λ/(2(√n_{core}²−n_{clad}²))), and that, when denoting M as the width of the metal mask that forms the core 13a, M>1.45λ/(2(√(n_{core}²−n_{clad}²))) is required.

For an optical waveguide to be single mode, the cutoff wavelength should be smaller than the wavelength in use, and be preferably set to 80 to 90% of the wavelength in use considering variations in actual fabrication processes. Higher refractive index difference is preferably used since high refractive index difference minimizes acceptable bending radius of a waveguide. Width/height of a core would be preferably chosen 6 to 8 μm considering the coupling loss to a fiber.

Appropriate combinations of the core height/width and the refractive index difference for 1310 nm wavelength are similar to what is listed in Table 1.

As stated in the above description, this invention features that a core of an optical waveguide having its width that matches to required one can be obtained without deposition of the residues generated through etching process since the core width reduced by etching is corrected by forming a masking layer that is wider than a required core width, and that a waveguide with low propagation loss and low coupling loss is obtained since the core width matches its design and has no residue deposition.

What is claimed is:

1. A method of fabricating an optical waveguide, said method comprising the steps of:
forming a core layer on a substrate or a first clad layer;
forming a masking layer on said core layer;
forming a photoresist layer on said masking layer;
patterning said photoresist layer by using a photomask;
patterning said masking layer wider than a required core width by using the patterned photoresist layer;
removing said masking layer after patterning said core layer to form a core by using the patterned masking layer; and
forming a second clad layer on said first clad layer so as to bury the patterned core.

2. A method of fabricating an optical waveguide as claimed in claim 1, wherein the width of the patterned masking layer is characterized by that the width of the core patterned by using said masking layer is equal to the required core width.

3. A method of fabricating an optical waveguide as claimed in claim 1, wherein when the cores sandwich a gap, said masking layer is patterned, so that a center position along the width of said patterned masking layer will be farther away from the gap than a center position along the width of the core.

4. A method of fabricating an optical waveguide as claimed in claim 1, wherein said masking layer is patterned wider than the required core width by optimizing at least either one of the following: a mask pattern of a photomask used in patterning the photoresist layer, the patterning condition of the photoresist layer, or the patterning condition of said masking layer.

5. A method of fabricating an optical waveguide as claimed in claim 1, wherein said masking layer and said core layer are patterned by reactive ion etching.

6. A method of fabricating an optical waveguide as claimed in claim 1, wherein the required core width is 8 μm when refractive index difference is 0.3%, 7 μm when the refractive index difference is 0.4%, 6 μm when the refractive index difference is 0.7%, and 5 μm when the refractive index difference is 1.0%.

7. A method of fabricating an optical waveguide as claimed in claim 1, wherein the width of said masking layer is 1.2 to 1.4 μm wider than the required core width, when it is 7 to 8 μm.

8. An optical waveguide at least comprised of a core and a clad, characterized by that the core is patterned by using a photomask, and that width of a part corresponding to the core of the photomask is wider than the core width.

9. An optical waveguide as claimed in claim 8, wherein the width is more than 0.5 μm wider than the core width.

10. An optical waveguide at least comprised of a core and clad, wherein the core width d is:
d<1.45λ/(2(√(n_{core}²−n_{clad}²)))
where a refractive index of the core is n_{core}, that of the clad is n_{clad}, and cutoff wavelength of the optical waveguide is λ,
and width M of a corresponding part of the masking layer that patterns the core will be:
M>1.45λ/(2(√(n_{core}²−n_{clad}²))).

11. An optical waveguide as claimed in claim 10, wherein the cutoff wavelength is 80 to 90% of the wavelength in use.
